(19) United States
(12) Patent Application Publication
(10) Pub. No.: US 2026/0192275 A1
(43) Pub. Date: Jul. 9, 2026

(54) MONITORING DEVICE FOR PRODUCTION PROCESS OF ORGANOSILICON SURFACTANT

(71) Applicant: JIANGSU HENGGUANG NEW MATERIAL CO., LTD., NANTONG (CN)

(72) Inventors: ZHONGJUN LI, BOZHOU (CN); ZHEN LI, BOZHOU (CN); GUANG LI, SUZHOU (CN)

(21) Appl. No.: 19/073,548

(22) Filed: Mar. 7, 2025

(30) Foreign Application Priority Data
Jan. 6, 2025 (CN) 202510013878.7

(51) Int. Cl. B01J 19/00; B01J 4/00; B01J 19/18; C09K 23/54; G01N 21/64

(52) U.S. Cl. CPC B01J 19/0006; B01J 4/007; B01J 19/0066; B01J 19/18; C09K 23/54; G01N 21/64; B01J 2204/002; B01J 2219/00186; G01N 2021/6495

(57) ABSTRACT

The present invention discloses a monitoring device for a production process of an organosilicon surfactant, which relates to the technical field of activator monitoring. The monitoring device comprises a tank body and a monitoring assembly; the monitoring assembly is arranged on one side of the tank body; the monitoring assembly comprises a sampling tube, a control valve, a sampling pump, an FEIR detecting device and a return tube; one side of the tank body is connected with the sampling tube; the control valve is connected in the middle of the sampling tube; the other end of the sampling tube is connected with the sampling pump; and one side of the sampling pump is connected with the FEIR detecting device through a pipeline.

### CROSS REFERENCE TO RELATED APPLICATIONS

The present disclosure claims the priority to the Chinese patent application with the filing NO. 202510013878.7, entitled “MONITORING DEVICE FOR PRODUCTION PROCESS OF ORGANOSILICON SURFACTANT” and filed on Jan. 6, 2025 with the Chinese Patent Office, the contents of which are incorporated in the present disclosure by reference in their entirety.

### TECHNICAL FIELD

The present invention relates to the technical field of activator monitoring, in particular to a monitoring device for a production process of an organosilicon surfactant.

### BACKGROUND

With the emergence of novel organosilicon materials, the organosilicon surfactant has been the focus of research in recent years. Because the structure of the organosilicon surfactant contains both organic groups and silico-oxygen bonds (Si-O-Si), the organosilicon surfactant not only has high surface activity of general hydrocarbon surfactants, but also has excellent properties, such as high and low temperature resistance, climate aging resistance, no toxicity, no corrosion, and physiological inertia, of inorganic silica, and can be used in textiles, pesticides, daily chemical products, etc.

In the production process of the organosilicon surfactant, hydrogen content will directly affect the performance. How to effectively control and accurately determine the hydrogen content in the production process has obvious theoretical and practical significance for the effective preparation of products. The current methods for determining the hydrogen content mainly include: the infrared method, the chemical method, the gasometric method, etc. The chemical method is relatively mature, but is complicated in operation and low in efficiency. The equipment required by the gasometric method is simple, but the volume of hydrogen varies greatly under the influence of temperature, and human operation has a great influence on the detection result, resulting in a large error in the measurement result.

Therefore, in view of this, a monitoring device for a production process of an organosilicon surfactant is proposed to research and improve the existing structure and deficiencies.

### SUMMARY

A purpose of the present invention is to provide a monitoring device for a production process of an organosilicon surfactant to solve the problems raised in the above background.

To achieve the above purpose, the present invention provides the following technical solution: a monitoring device for a production process of an organosilicon surfactant comprises a tank body and a monitoring assembly; the monitoring assembly is arranged on one side of the tank body; the monitoring assembly comprises a sampling tube, a control valve, a sampling pump, an FEIR detecting device and a return tube; one side of the tank body is connected with the sampling tube; the control valve is connected in the middle of the sampling tube; the other end of the sampling tube is connected with the sampling pump; one side of the sampling pump is connected with the FEIR detecting device through a pipeline; and the other side of the FEIR detecting device is provided with the return tube.

Further, the FEIR detecting device is an infrared detecting device, and the return tube is communicated with the interior of the tank body.

Further, an upper side of the tank body is provided with a feed hopper, a lower side of the tank body is provided with a discharge port, and an upper part of the tank body is provided with a processing assembly.

Further, the processing assembly comprises an air extracting port, an air extracting tube, an air extracting pump and a ventilation tube; one side of an upper wall of the tank body is provided with the air extracting port; the air extracting tube is arranged in the air extracting port; one side of the air extracting tube is provided with the air extracting pump; and one side of the air extracting pump is connected with the ventilation tube.

Further, the processing assembly also comprises an air box, an air delivery pump and an air delivery tube; one side of the ventilation tube is connected with the air box; one side of the air box is connected with the air delivery pump through a pipeline; and one side of the air delivery pump is connected with the air delivery tube.

Further, a separating membrane is arranged in the air box; the ventilation tube is communicated with the air delivery tube; and solenoid valves are arranged at the connections of the ventilation tube with the air box and the air delivery tube.

Further, a driving motor is arranged at one side above the tank body, one side of the driving motor is connected with a driving wheel, and a mixing assembly is arranged in the tank body.

Further, the mixing assembly comprises a stirring shaft, a transmission wheel and a ventilation chamber; the stirring shaft is rotatably connected in the tank body; a top end of the stirring shaft is connected with the transmission wheel; the ventilation chamber is arranged in the center of the stirring shaft and the transmission wheel; the ventilation tube is communicated with the ventilation chamber; and the driving wheel is engaged with the transmission wheel.

Further, the mixing assembly also comprises stirring rods, a center wheel and planet gears; the stirring rods are symmetrically connected around the stirring shaft; one side of the stirring shaft is provided with the center wheel; the planet gears are symmetrically arranged around the center wheel; the stirring rods are hollow tubes; and ends of the stirring rods are provided with check valves.

Further, the mixing assembly also comprises a supporting plate, annular grooves, rotating rings, an annular plate and scrapers; the supporting plate is arranged below the center wheel; the close sides of the supporting plate and the tank body are provided with the annular grooves; the rotating rings are clamped and connected in the annular grooves; the annular plate is connected between the rotating rings; the scrapers are symmetrically connected around the annular plate; and the center wheel, the planet gears and the annular plate are engaged with each other.

The present invention provides the monitoring device for the production process of the organosilicon surfactant, which has the following beneficial effects: when in use, the hydrogen content of a sample in the production process can be determined by using a linear relationship established in a laboratory to monitor and observe the process of the reaction in real time in the production process, and regulate the device according to the detection result to optimize the production process and increase the production efficiency. Moreover, during regulation, the integration of hydrogen can be accelerated and the materials can be prevented from adhering to the inner wall of the device.
1. Before the present invention is used, a standard curve (linear relationship) is drawn at first in the laboratory. After the linear relationship is established, the materials can be put into the tank body from a feed port for stirring and processing. In the production process, the control valve is opened regularly, and the sampling pump can extract the reaction product in the tank body through the sampling tube into the FEIR detecting device for detection, so as to determine the hydrogen content of the sample in the production process by using the established linear relationship. The reaction product after detection can leave the FEIR detecting device through the return tube and return into the tank body to continue to participate in production. At the same time, the operation of the processing assembly is controlled according to the detection result of the FEIR detecting device, so as to regulate the production process. To sum up, during use, the hydrogen content of the sample in the production process can be determined by using the linear relationship established in the laboratory, so as to monitor and observe the process of the reaction in real time in the production process.
2. In the production process of the present invention, the air extracting pump can extract the air in the tank body from the air extracting tube into the ventilation tube through the air extracting port, and deliver the air back into the tank body through the air delivery tube. While ensuring the stability of air pressure in the tank body, the gas in the upper part of the tank body can fully participate in the reaction. When too high hydrogen content is detected, the air extracting pump delivers the air in the upper part of the tank body into the air box through the ventilation tube, and the hydrogen is separated through the separating membrane in the air box and stored in the upper part of the air box. When too low hydrogen content is detected, the air delivery pump can extract out the hydrogen in the upper part of the air box and deliver the hydrogen into the tank body through the air delivery tube, so as to regulate the reaction process of the materials, optimize the production process and increase the production efficiency. During air extracting and air delivery, the solenoid valves arranged at the connections of the ventilation tube with the air box and the air delivery tube can adjust an airflow path according to the detection result to ensure the smooth progress of the regulation process. To sum up, during use, the device can be regulated according to the detection result, so as to optimize the production process and increase the production efficiency.
3. In the present invention, after the materials enter the tank body, the driving motor is started, and the driving wheel can drive the transmission wheel to rotate, so that the stirring rods can be driven by the stirring shaft to rotate in the tank body, and the materials can be mixed and stirred. The check valves at the ends of the stirring rods can prevent the materials from entering the stirring rods. When the stirring shaft rotates, the center wheel can be driven to rotate synchronously, and the planet gears drive the annular plate to rotate. The supporting plate and the tank body can restrict the annular plate through the annular grooves and the rotating rings to avoid the deviation of the annular plate during rotation. The supporting plate can shield gaps among the annular plate, the planet gears and the center wheel through the annular grooves and the rotating rings to prevent the materials from splashing among the annular plate, the planet gears and the center wheel during stirring to avoid affecting normal transmission. When the annular plate rotates, the scraper can be driven to move synchronously in the tank body, and the movement direction of the scraper is opposite to the movement direction of the stirring rods, so as to increase the mixing efficiency of the materials. At the same time, the inner wall of the tank body can be cleaned to prevent the materials from adhering to the inner wall of the tank body and causing difficulty in cleaning. When the gas is delivered into the tank body by the air delivery tube, after the gas enters the ventilation chamber from the air delivery tube, the gas can enter the tank body through the stirring rods and are directly mixed with the materials as the stirring rods move, to accelerate the gas integration and reaction. To sum up, during use, the mixing efficiency of the materials can be increased, the integration and the reaction of the hydrogen can be accelerated, and the materials can be prevented from adhering to the inner wall of the device.

### DESCRIPTION OF DRAWINGS

FIG. 1 is an overall three-dimensional structural schematic diagram of a monitoring device for a production process of an organosilicon surfactant in the present invention;

FIG. 2 is an overall front structural schematic diagram of a monitoring device for a production process of an organosilicon surfactant in the present invention;

FIG. 3 is a semi-sectional three-dimensional exploded structural schematic diagram of a tank body of a monitoring device for a production process of an organosilicon surfactant in the present invention;

FIG. 4 is a semi-sectional three-dimensional structural schematic diagram of a monitoring device for a production process of an organosilicon surfactant in the present invention;

FIG. 5 is a sectional front structural schematic diagram of a monitoring device for a production process of an organosilicon surfactant in the present invention;

FIG. 6 is a semi-sectional three-dimensional exploded structural schematic diagram of a stirring shaft of a monitoring device for a production process of an organosilicon surfactant in the present invention.

In the figures: 1. tank body; 2. monitoring assembly; 201. sampling tube; 202. control valve; 203. sampling pump; 204. FEIR detecting device; 205. return tube; 3. feed hopper; 4. discharge port; 5. processing assembly; 501. air extracting port; 502. air extracting tube; 503. air extracting pump; 504. ventilation tube; 505. air box; 506. air delivery pump; 507. air delivery tube; 6. driving motor; 7. driving wheel; 8. mixing assembly; 801. stirring shaft; 802. transmission wheel; 803. ventilation chamber; 804. stirring rod; 805. center wheel; 806. planet gear; 807. supporting plate; 808. annular groove; 809. rotating ring; 810. annular plate; 811. scraper.

### DETAILED DESCRIPTION

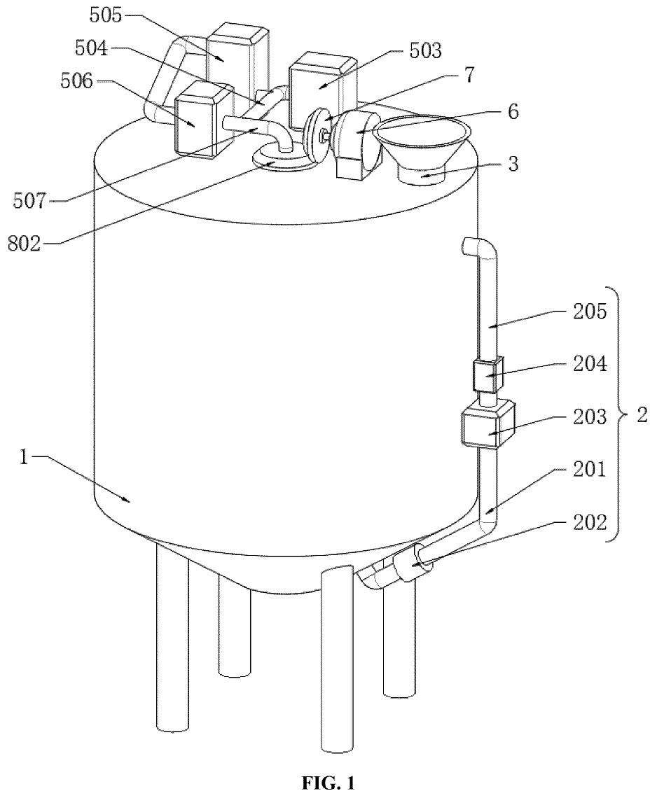

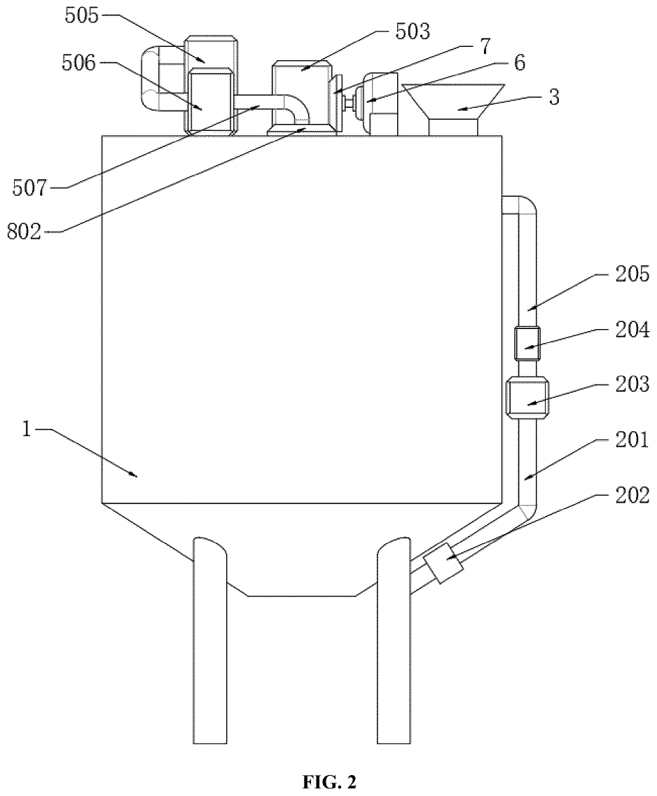

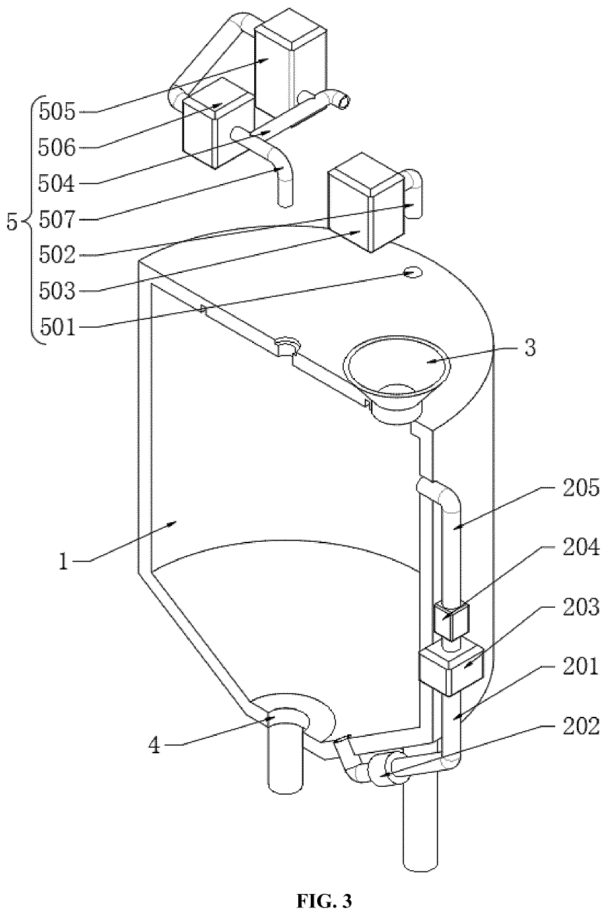

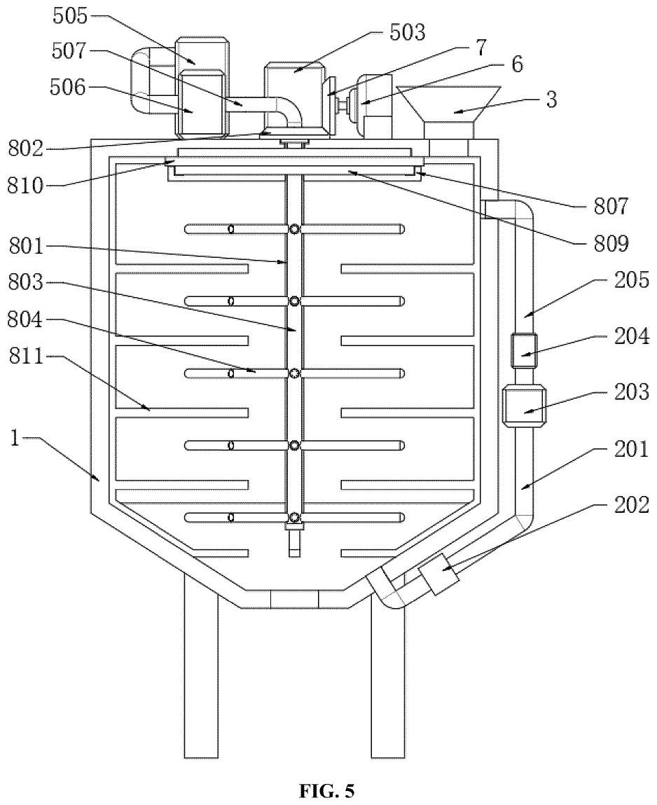

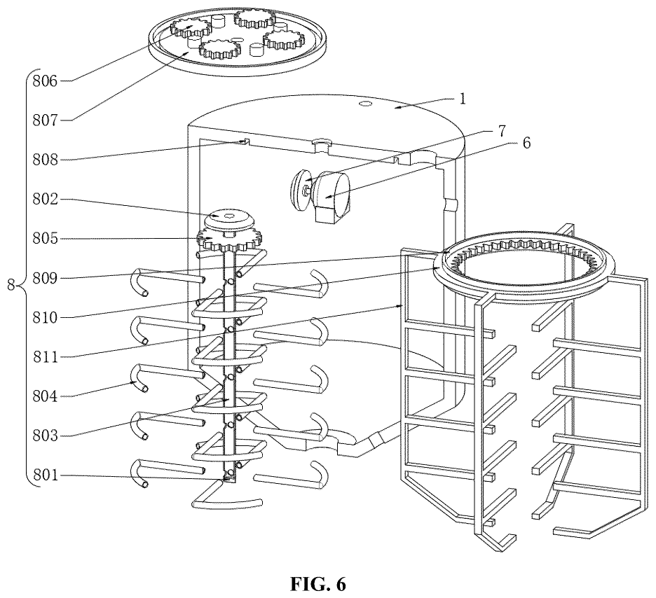

By referring to FIG. 1 to FIG. 6, the present invention provides the following technical solution: a monitoring device for a production process of an organosilicon surfactant comprises a tank body 1 and a monitoring assembly 2; the monitoring assembly 2 is arranged on one side of the tank body 1; the monitoring assembly 2 comprises a sampling tube 201, a control valve 202, a sampling pump 203, an FEIR detecting device 204 and a return tube 205; one side of the tank body 1 is connected with the sampling tube 201; the control valve 202 is connected in the middle of the sampling tube 201; the other end of the sampling tube 201 is connected with the sampling pump 203; one side of the sampling pump 203 is connected with the FEIR detecting device 204 through a pipeline; and the other side of the FEIR detecting device 204 is provided with the return tube 205.

By referring to FIG. 1 to FIG. 5, the FEIR detecting device 204 is an infrared detecting device, and the return tube 205 is communicated with the interior of the tank body 1. An upper side of the tank body 1 is provided with a feed hopper 3, a lower side of the tank body 1 is provided with a discharge port 4, and an upper part of the tank body 1 is provided with a processing assembly 5. The processing assembly 5 comprises an air extracting port 501, an air extracting tube 502, an air extracting pump 503 and a ventilation tube 504; one side of an upper wall of the tank body 1 is provided with the air extracting port 501; the air extracting tube 502 is arranged in the air extracting port 501; one side of the air extracting tube 502 is provided with the air extracting pump 503; and one side of the air extracting pump 503 is connected with the ventilation tube 504. The processing assembly 5 further comprises an air box 505, an air delivery pump 506 and an air delivery tube 507; one side of the ventilation tube 504 is connected with the air box 505; one side of the air box 505 is connected with the air delivery pump 506 through a pipeline; and one side of the air delivery pump 506 is connected with the air delivery tube 507. A separating membrane is arranged in the air box 505; the ventilation tube 504 is communicated with the air delivery tube 507; and solenoid valves are arranged at the connections of the ventilation tube 504 with the air box 505 and the air delivery tube 507.

Specific operation is as follows: Before use, a linear relationship of a standard curve is drawn at first in a laboratory. After the linear relationship is established, the materials can be put into the tank body 1 from a feed port for stirring and processing. In the production process, the control valve 202 is opened regularly, and the sampling pump 203 can extract the reaction product in the tank body 1 through the sampling tube 201 into the FEIR detecting device 204 for detection, so as to determine the hydrogen content of the sample in the production process by using the established linear relationship. The reaction product after detection can leave the FEIR detecting device 204 through the return tube 205 and return into the tank body 1 to continue to participate in production. At the same time, the operation of the processing assembly 5 is controlled according to the detection result of the FEIR detecting device 204, so as to regulate the production process. To sum up, during use, the hydrogen content of the sample in the production process can be determined by using the linear relationship established in the laboratory, so as to monitor and observe the process of the reaction in real time in the production process. In the production process, the air extracting pump 503 can extract the air in the tank body 1 from the air extracting tube 502 into the ventilation tube 504 through the air extracting port 501, and deliver the air back into the tank body 1 through the air delivery tube 507. While ensuring the stability of air pressure in the tank body 1, the gas in the upper part of the tank body 1 can fully participate in the reaction. When too high hydrogen content is detected, the air extracting pump 503 delivers the air in the upper part of the tank body 1 into the air box 505 through the ventilation tube 504, and the hydrogen is separated through the separating membrane in the air box 505 and stored in the upper part of the air box 505. When too low hydrogen content is detected, the air delivery pump 506 can extract out the hydrogen in the upper part of the air box 505 and deliver the hydrogen into the tank body 1 through the air delivery tube 507, so as to regulate the reaction process of the materials, optimize the production process and increase the production efficiency. During air extracting and air delivery, the solenoid valves arranged at the connections of the ventilation tube 504 with the air box 505 and the air delivery tube 507 can adjust an airflow path according to the detection result to ensure the smooth progress of the regulation process. To sum up, during use, the device can be regulated according to the detection result, so as to optimize the production process and increase the production efficiency.

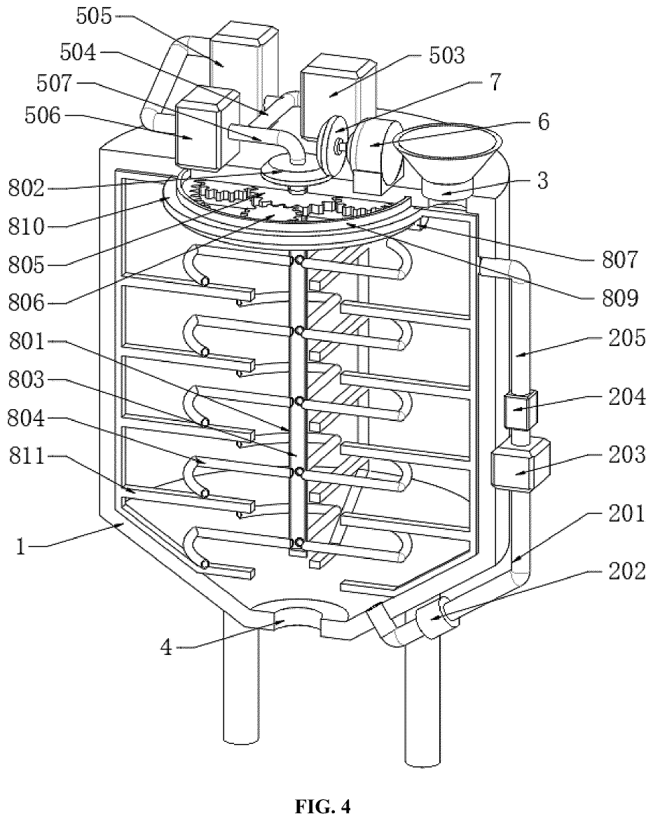

By referring to FIG. 4 to FIG. 6, a driving motor 6 is arranged at one side above the tank body 1, one side of the driving motor 6 is connected with a driving wheel 7, and a mixing assembly 8 is arranged in the tank body 1. The mixing assembly 8 comprises a stirring shaft 801, a transmission wheel 802 and a ventilation chamber 803; the stirring shaft 801 is rotatably connected in the tank body 1; a top end of the stirring shaft 801 is connected with the transmission wheel 802; the ventilation chamber 803 is arranged in the center of the stirring shaft 801 and the transmission wheel 802; the ventilation tube 504 is communicated with the ventilation chamber 803; and the driving wheel 7 is engaged with the transmission wheel 802. The mixing assembly 8 further comprises stirring rods 804, a center wheel 805 and planet gears 806; the stirring rods 804 are symmetrically connected around the stirring shaft 801; one side of the stirring shaft 801 is provided with the center wheel 805; the planet gears 806 are symmetrically arranged around the center wheel 805; the stirring rods 804 are hollow tubes; and ends of the stirring rods 804 are provided with check valves. The mixing assembly 8 further comprises a supporting plate 807, annular grooves 808, rotating rings 809, an annular plate 810 and scrapers 811; the supporting plate 807 is arranged below the center wheel 805; the close sides of the supporting plate 807 and the tank body 1 are provided with the annular grooves 808; the rotating rings 809 are clamped and connected in the annular grooves 808; the annular plate 810 is connected between the rotating rings 809; the scrapers 811 are symmetrically connected around the annular plate 810; and the center wheel 805, the planet gears 806 and the annular plate 810 are engaged with each other.

Specific operation is as follows: After the materials enter the tank body 1, the driving motor 6 is started, and the driving wheel 7 can drive the transmission wheel 802 to rotate, so that the stirring rods 804 can be driven by the stirring shaft 801 to rotate in the tank body 1, and the materials can be mixed and stirred. The check valves at the ends of the stirring rods 804 can prevent the materials from entering the stirring rods 804. When the stirring shaft 801 rotates, the center wheel 805 can be driven to rotate synchronously, and the planet gears 806 drive the annular plate 810 to rotate. The supporting plate 807 and the tank body 1 can restrict the annular plate 810 through the annular grooves 808 and the rotating rings 809 to avoid the deviation of the annular plate 810 during rotation. The supporting plate 807 can shield gaps among the annular plate 810, the planet gears 806 and the center wheel 805 through the annular grooves 808 and the rotating rings 809 to prevent the materials from splashing among the annular plate 810, the planet gears 806 and the center wheel 805 during stirring to avoid affecting normal transmission. When the annular plate 810 rotates, the scraper 811 can be driven to move synchronously in the tank body 1, and the movement direction of the scraper 811 is opposite to the movement direction of the stirring rods 804, so as to increase the mixing efficiency of the materials. At the same time, the inner wall of the tank body 1 can be cleaned to prevent the materials from adhering to the inner wall of the tank body 1 and causing difficulty in cleaning. When the gas is delivered into the tank body 1 by the air delivery tube 507, after the gas enters the ventilation chamber 803 from the air delivery tube 507, the gas can enter the tank body 1 through the stirring rods 804 and are directly mixed with the materials as the stirring rods 804 move, to accelerate the gas integration and reaction. To sum up, during use, the mixing efficiency of the materials can be increased, the integration and the reaction of the hydrogen can be accelerated, and the materials can be prevented from adhering to the inner wall of the device.

To sum up, when the monitoring device for the production process of the organosilicon surfactant is used, the linear relationship of the standard curve is drawn at first in the laboratory. When the standard curve is drawn, 9.766 g of hydrogen-containing silicone oil with hydrogen content of 1.024% is accurately weighed into a 100 ml dry small beaker at first, diluted with carbon tetrachloride, quantitatively transferred to a 100 ml volumetric flask, diluted with carbon tetrachloride to the scale and shaken well to obtain 1.000 mgH/ml standard solution. 0.50, 1.00, 1.50, 2.00, 2.50, 3.00, 3.50, 4.00 and 4.50 ml of the above standard solutions are transferred into nine 10 ml volumetric flasks respectively, diluted with carbon tetrachloride to the scale, and shaken well. The above prepared standard solutions are transferred to a fixed sealed liquid pool by a microsyringe in sequence. Carbon tetrachloride blank is used as a reference. Scanning is conducted within the range of 2500-2000 cm⁻¹. An infrared spectrogram is recorded, absorbance is determined and a standard curve is drawn. After the linear relationship is established, the materials can be put into the tank body 1 from the feed port for stirring and processing. After the materials enter the tank body 1, the driving motor 6 is started, and the driving wheel 7 can drive the transmission wheel 802 to rotate so that the stirring rods 804 can be driven by the stirring shaft 801 to rotate in the tank body 1. The materials are mixed and stirred. The check valves at the ends of the stirring rods 804 can prevent the materials from entering the stirring rods 804. When the stirring shaft 801 rotates, the center wheel 805 can be driven to rotate synchronously, and the planet gears 806 drive the annular plate 810 to rotate. The supporting plate 807 and the tank body 1 can restrict the annular plate 810 through the annular grooves 808 and the rotating rings 809 to avoid the deviation of the annular plate 810 during rotation. The supporting plate 807 can shield gaps among the annular plate 810, the planet gears 806 and the center wheel 805 through the annular grooves 808 and the rotating rings 809 to prevent the materials from splashing among the annular plate 810, the planet gears 806 and the center wheel 805 during stirring to avoid affecting normal transmission. When the annular plate 810 rotates, the scraper 811 can be driven to move synchronously in the tank body 1, and the movement direction of the scraper 811 is opposite to the movement direction of the stirring rods 804, so as to increase the mixing efficiency of the materials. At the same time, the inner wall of the tank body 1 can be cleaned to prevent the materials from adhering to the inner wall of the tank body 1 and causing difficulty in cleaning. In the production process, the control valve 202 is opened regularly, and the sampling pump 203 can extract the reaction product in the tank body 1 through the sampling tube 201 into the FEIR detecting device 204 for detection, so as to determine the hydrogen content of the sample in the production process by using the established linear relationship. The reaction product after detection can leave the FEIR detecting device 204 through the return tube 205 and return into the tank body 1 to continue to participate in production. At the same time, the operation of the processing assembly 5 is controlled according to the detection result of the FEIR detecting device 204, so as to regulate the production process. In the production process, the air extracting pump 503 can extract the air in the tank body 1 from the air extracting tube 502 into the ventilation tube 504 through the air extracting port 501, and deliver the air back into the tank body 1 through the air delivery tube 507. While ensuring the stability of air pressure in the tank body 1, the gas in the upper part of the tank body 1 can fully participate in the reaction. When too high hydrogen content is detected, the air extracting pump 503 delivers the air in the upper part of the tank body 1 into the air box 505 through the ventilation tube 504, and the hydrogen is separated through the separating membrane in the air box 505 and stored in the upper part of the air box 505. When too low hydrogen content is detected, the air delivery pump 506 can extract out the hydrogen in the upper part of the air box 505 and deliver the hydrogen into the tank body 1 through the air delivery tube 507, so as to regulate the reaction process of the materials, optimize the production process and increase the production efficiency. During air extracting and air delivery, the solenoid valves arranged at the connections of the ventilation tube 504 with the air box 505 and the air delivery tube 507 can adjust an airflow path according to the detection result to ensure the smooth progress of the regulation process. When the gas is delivered into the tank body 1 by the air delivery tube 507, after the gas enters the ventilation chamber 803 from the air delivery tube 507, the gas can enter the tank body 1 through the stirring rods 804 and are directly mixed with the materials as the stirring rods 804 move, to accelerate the gas integration and reaction.

Embodiments of the present invention are provided for example and description, but are not exhaustive or used to limit the present invention to the disclosed forms. Many modifications and changes are apparent to those ordinary skilled in the art. The purpose of selecting and describing the embodiments is to preferably illustrate the principles and practical applications of the present invention, so that those ordinary skilled in the art can understand the present invention, thereby designing various modified embodiments applied to specific uses.

What is claimed is:

1. A monitoring device for a production process of an organosilicon surfactant, comprising a tank body and a monitoring assembly, wherein the monitoring assembly is arranged on one side of the tank body ; the monitoring assembly comprises a sampling tube, a control valve, a sampling pump, an FEIR detecting device and a return tube ; one side of the tank body is connected with the sampling tube ; the control valve is connected in the middle of the sampling tube ; the other end of the sampling tube is connected with the sampling pump ; one side of the sampling pump is connected with the FEIR detecting device through a pipeline; and the other side of the FEIR detecting device is provided with the return tube.

2. The monitoring device for the production process of the organosilicon surfactant according to claim 1, wherein the FEIR detecting device is an infrared detecting device, and the return tube is communicated with the interior of the tank body.

3. The monitoring device for the production process of the organosilicon surfactant according to claim 1, wherein an upper side of the tank body is provided with a feed hopper, a lower side of the tank body is provided with a discharge port, and an upper part of the tank body is provided with a processing assembly.

4. The monitoring device for the production process of the organosilicon surfactant according to claim 3, wherein the processing assembly comprises an air extracting port, an air extracting tube, an air extracting pump and a ventilation tube ; one side of an upper wall of the tank body is provided with the air extracting port ; the air extracting tube is arranged in the air extracting port; one side of the air extracting tube is provided with the air extracting pump; and one side of the air extracting pump is connected with the ventilation tube.

5. The monitoring device for the production process of the organosilicon surfactant according to claim 4, wherein the processing assembly further comprises an air box, an air delivery pump and an air delivery tube; one side of the ventilation tube is connected with the air box; one side of the air box is connected with the air delivery pump through a pipeline; and one side of the air delivery pump is connected with the air delivery tube.

6. The monitoring device for the production process of the organosilicon surfactant according to claim 5, wherein a separating membrane is arranged in the air box ; the ventilation tube is communicated with the air delivery tube; and solenoid valves are arranged at the connections of the ventilation tube with the air box and the air delivery tube.

7. The monitoring device for the production process of the organosilicon surfactant according to claim 5, wherein a driving motor is arranged at one side above the tank body, one side of the driving motor is connected with a driving wheel, and a mixing assembly is arranged in the tank body.

8. The monitoring device for the production process of the organosilicon surfactant according to claim 7, wherein the mixing assembly comprises a stirring shaft, a transmission wheel and a ventilation chamber; the stirring shaft is rotatably connected in the tank body ; a top end of the stirring shaft is connected with the transmission wheel; the ventilation chamber is arranged in the center of the stirring shaft and the transmission wheel; the ventilation tube is communicated with the ventilation chamber; and the driving wheel is engaged with the transmission wheel.

9. The monitoring device for the production process of the organosilicon surfactant according to claim 8, wherein the mixing assembly further comprises stirring rods, a center wheel and planet gears ; the stirring rods are symmetrically connected around the stirring shaft; one side of the stirring shaft is provided with the center wheel; the planet gears are symmetrically arranged around the center wheel; the stirring rods are hollow tubes; and ends of the stirring rods are provided with check valves.

10. The monitoring device for the production process of the organosilicon surfactant according to claim 9, wherein the mixing assembly further comprises a supporting plate, annular grooves, rotating rings, an annular plate and scrapers; the supporting plate is arranged below the center wheel; the close sides of the supporting plate and the tank body are provided with the annular grooves; the rotating rings are clamped and connected in the annular grooves; the annular plate is connected between the rotating rings; the scrapers are symmetrically connected around the annular plate; and the center wheel, the planet gears and the annular plate are engaged with each other.
